(19) United States
(12) Patent Application Publication
(10) Pub. No.: US 2005/0072659 A1
(43) Pub. Date: Apr. 7, 2005

(54) Mutiple-function products with user-friendly operation interface

(76) Inventors: Chen-Liang Huang, Taipei (TW); Shih-Yang Lee, Taipei (TW)

Correspondence Address: BIRCH STEWART KOLASCH & BIRCH, PO BOX 747, FALLS CHURCH, VA, 22040-0747, US

(21) Appl. No.: 10/909,385

(22) Filed: Aug. 3, 2004

(30) Foreign Application Priority Data
Oct. 3, 2003 (TW) 92217792

(51) Int. Cl. H01H 9/00

(52) U.S. Cl. 200/1 R

(57) ABSTRACT

A multi-function product that includes an operation panel is provided. The operation panel includes a selection device of mechanical-type for users to select the operation mode and/or status.

This Application claims priority to Taiwan Patent Application No. 92217792 filed on Oct. 03, 2003.

### FIELD OF INVENTION

The present invention relates to a multiple-function product with a user-friendly operation interface.

### BACKGROUND OF THE INVENTION

Multiple-function products are designed to integrate multiple functions into one machine. Typically, the commercially available multiple-function products integrate two or more traditional office machines into one, such as a fax machine, a copy machine and a scanner.

However, these multiple-function products usually employ “multiple-level menu” interface to go through various functions due to the powerful but complicated functions.

The user always needs to go through different levels of the menu to make a selection regardless of whether a simple or complicated function is wanted. It is definitely a hassle to most users.

Therefore, there exists a demand for multiple-function products with a more straightforward interface that allows quick access to frequently used functions.

### SUMMARY OF THE INVENTION

One aspect of the present invention provides a multiple-function product with a simplified interface that allows easier operation of the device.

Another aspect of the present invention provides a multiple-function product with an intuitive interface for users.

Still another aspect of the present invention provides a control panel with a simplified interface that allows quick access to frequently used functions.

The present invention discloses a multi-function product with a user-friendly control panel. The control panel is characterizing in that the control panel includes a mechanical selection device for setting an operation mode and/or a state of the multi-function product.

When using the multi-function product of the present invention, the user can easily and intuitively access some frequently used functions, even without referring to the user's manual. This design evolves from the “user-friendly” concept.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 is a perspective view of the multi-function product of the present invention.

FIG. 2 is a perspective view of a preferred embodiment of the first example of the control panel of the multi-function product of the present invention.

FIG. 3 is a perspective view of a horizontally switchable selection device on the control panel of the multi-function product of the present invention.

FIG. 4 is a perspective view of a vertically switchable selection device on the control panel of the multi-function product of the present invention.

FIG. 5 is a perspective view of a dial-like selection device on the control panel of the multi-function product of the present invention.

FIG. 6 is a perspective view of a scroll device on the control panel of the multi-function product of the present invention.

FIG. 7 is a perspective view of a preferred embodiment of the second example of the control panel of the multi-function product of the present invention.

### DETAILED DESCRIPTION

The present invention provides a control panel with a simplified interface as well as a multiple-function product with such a control panel. Preferably, the multiple-function product has two or more operation modes. It can be used as a fax machine, a copy machine, a scanner, a printer or a phone. In addition, it may be able to carry out inkjet printing or laser printing in either monotone, gray scale, or color.

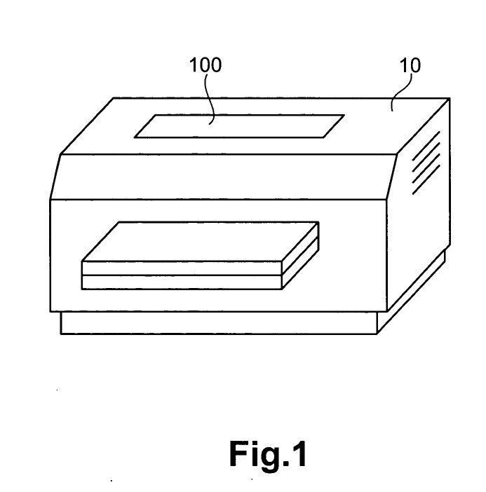

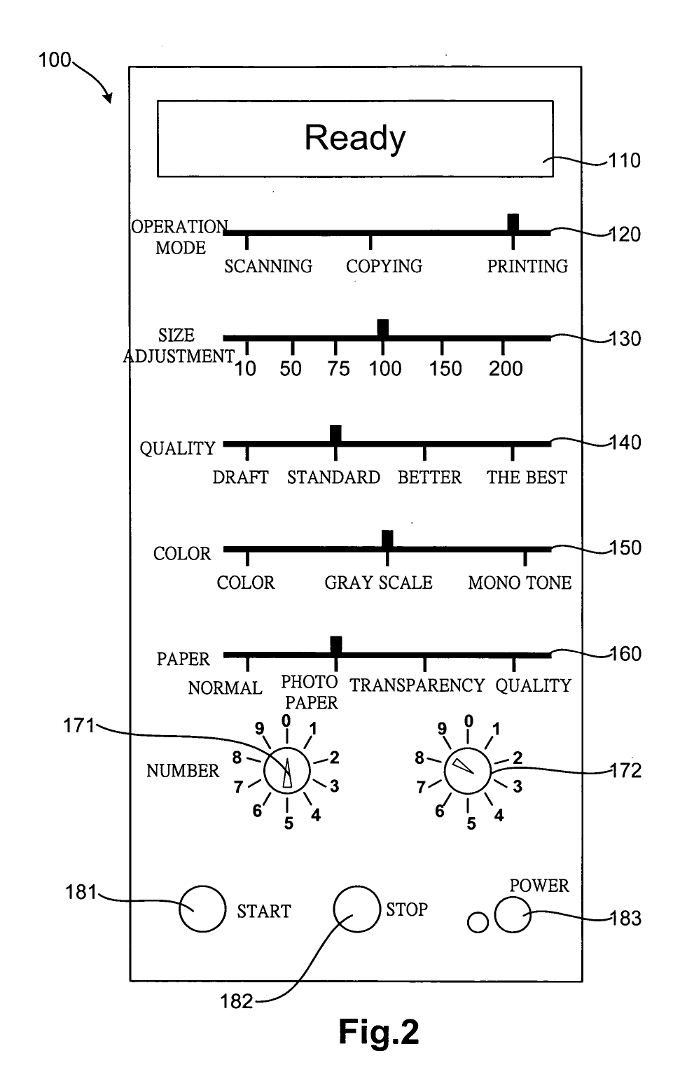

FIG. 1 is a perspective view of the multi-function product 10 with a control panel 100 of the first embodiment of the present invention. FIG. 2 is a perspective view of a preferred embodiment of control panel 100. It is noted that persons skilled in the art may modify all the possible embodiments to meet the practical demands without departing from the gist of the present invention. Control panel 100 includes one or more mechanical selection device(s), such as a mode selection device 120 (for example, for scanning, copying, printing), size adjustment (state) device 130, quality (state) selection device 140, color (state) selection device 150, paper (state) selection device 160 and quantity (state) selection device 171 and 172, illustrating each function by characters or by figures. Moreover, control panel 100 may further include a button and/or a screen for carrying out other functions, such as screen 110, start button 181, stop button 182 and/or power button 183. Screen 110 indicates the current mode and other states of machine 10. Start button 181 and stop button 182 control the on/off-state of different functions, respectively. Power button 183 is in charge of the power supply of machine 10.

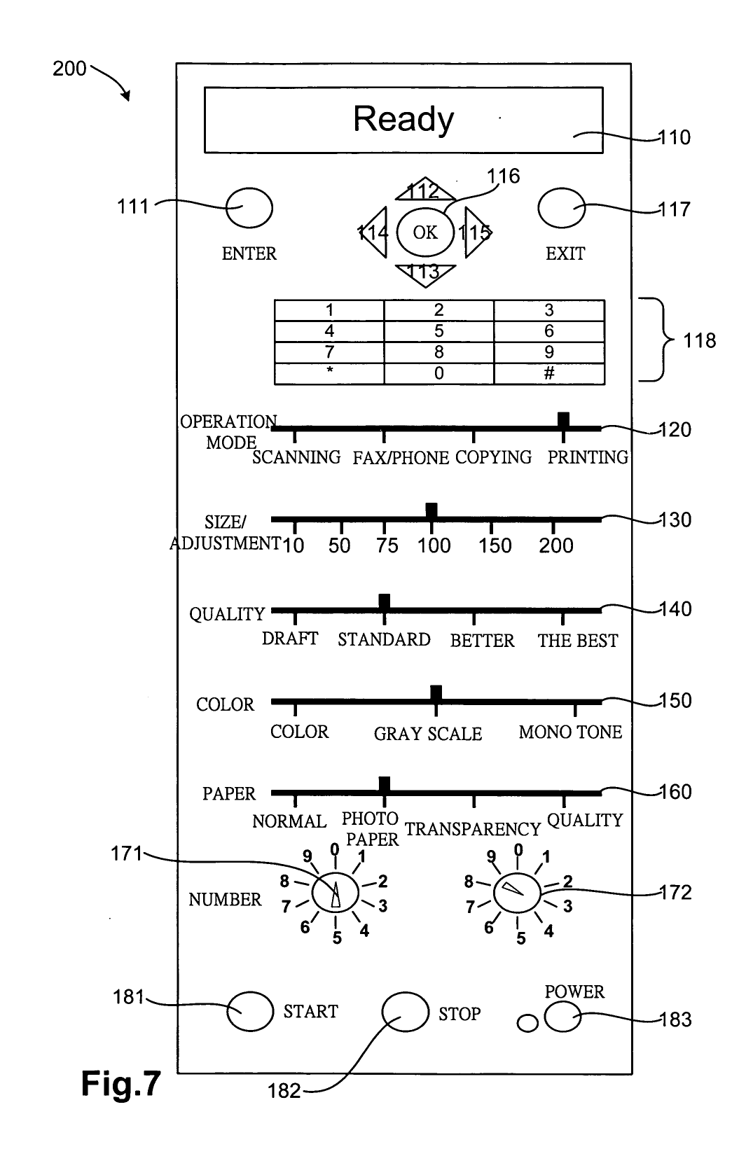

These mechanical selection devices 120, 130, 140, 150, 160, 171, 172, 181, 182, 183 may individually include two or more operation modes and/or states. For instance, please refer to FIGS. 2 and 7, the selection devices 120 may include switchable scanning mode, fax/phone mode, copying mode and printing mode for users to switch. Size adjustment (state) device 130 may optionally include various adjustable sizes, such as 10%, 50%, 75%, 100%, 150%, 200%. Quality (state) selection device 140 may optionally include various switchable modes, such as draft, standard, better and the best. Color (state) selection device 150 may optionally include monotone mode, gray scale mode or color mode. Paper (state) selection device 160 may switch between normal mode, photo paper mode, transparency mode and quality mode. Quantity (state) selection device 171 and 172 may help users set the desired number between 1 and 99. For example, the number illustrated in FIG. 2 is 3.

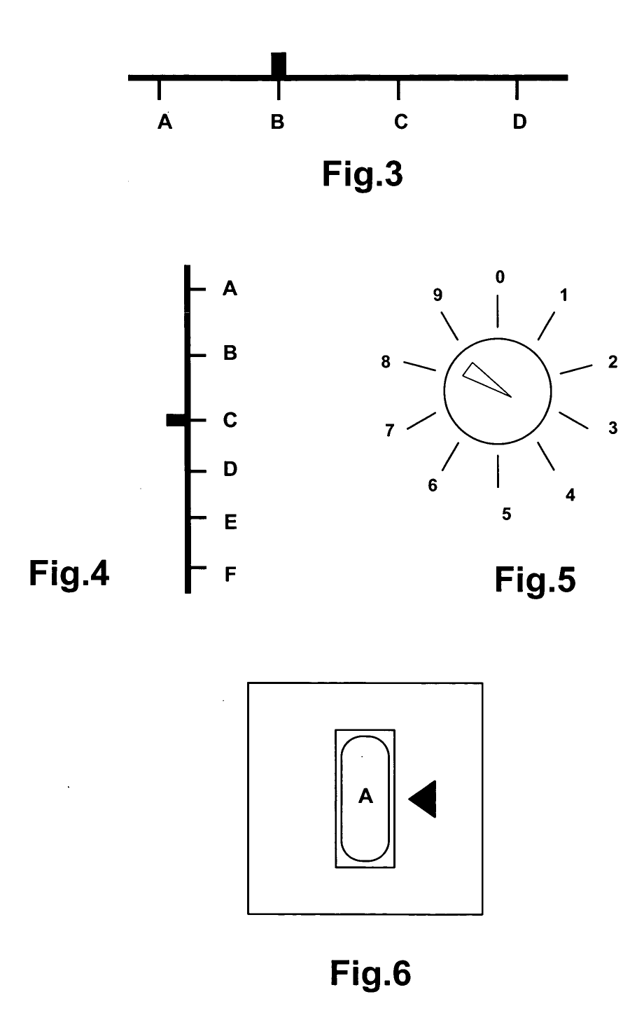

As shown in FIGS. 3 to 6, the mechanical selection devices on the control panel of the multiple-function product of the present invention may be in various forms, such as a horizontally switchable selection device (FIG. 3), a vertically switchable selection device (FIG. 4), a dial-like selection device (FIG. 5) and a scroll device (FIG. 6).

Because the design concept of control panel 100 of the multiple-function product is based on common sense, users can easily access some frequently used functions, even without referring to the user's manual.

Please refer to FIG. 7. The second embodiment of the present invention discloses another example of the control panel 200. Control panel 200 includes a set of keys 111, 112, 113, 114, 115, 116, 117, and 118 to carry out a series of selection functions as well as operation functions, and one or more selection device(s) 120, 130, 140, 150, 160, 171, 172, 181, 182, 183. As stated above, selection device 120 may include two or more operation modes (for example, scanning, fax/phone, copying, and printing) and illustrate every possible function by characters or by figures. The mechanical selection devices may be in various forms, such as a horizontally switchable selection device (FIG. 3), a vertically switchable selection device (FIG. 4), a dial-like selection device (FIG. 5) and a scroll device (FIG. 6). Furthermore, functions that are not directly accessible by mechanical selection devices can be accessed by other buttons or keys under the indication of screen 110. For example, some functions may be carried out through enter 111 and exit 117, such as the self-cleaning mode of an inkjet printer. Navigation buttons 112, 113, 114, 115 respectively correspond to the orientations in the cascading menu. Users may use OK button to confirm the selection. Keypad 118 represents a telephone keypad, commonly used in the fax/phone mode. The functions or properties of other mechanical selection devices on control panel 200 of the second embodiment are substantially the same as those in the first embodiment and therefore repetitious descriptions are not made.

By means of the detailed descriptions of what is presently considered to be the most practical and preferred embodiments of the subject invention, it is the expectation that the features and the gist thereof are plainly revealed. Nevertheless, these above-mentioned illustrations are not intended to be construed in a limiting sense. Instead, it should be well understood that any analogous variation and equivalent arrangement is supposed to be covered within the spirit and scope to be protected and that the interpretation of the scope of the subject invention would therefore as much as broadly apply.

1. A multi-function product comprising a control panel, characterizing in that said control panel comprises a mechanical selection device for setting an operation mode and/or a state of said multi-function product.

2. The multi-function product of claim 1, wherein said selection device is a horizontally switchable selection device.

3. The multi-function product of claim 1, wherein said mechanical selection device is a vertically switchable selection device.

4. The multi-function product of claim 1, wherein said mechanical selection device is a dial-like selection device.

5. The multi-function product of claim 1, wherein said mechanical selection device is a scroll device.

6. The multi-function product of claim 1, wherein said control panel further comprises a button and/or a screen.
